(19) United States
(12) Patent Application Publication
(10) Pub. No.: US 2015/0350832 A1
(43) Pub. Date: Dec. 3, 2015

(54) APPARATUS AND METHOD OF REFINING AN ESTIMATED POSITION IN A WIRELESS NETWORK

(71) Applicant: QUALCOMM Incorporated, San Diego, CA (US)

(72) Inventors: Yin CHEN, Campbell, CA (US); Sameera PODURI, Sunnyvale, CA (US); Payam PAKZAD, Mountain View, CA (US)

(73) Assignee: QUALCOMM Incorporated, San Diego, CA (US)

(21) Appl. No.: 14/292,021

(22) Filed: May 30, 2014

(51) Int. Cl. H04W 4/02; H04W 4/04

(52) U.S. Cl. CPC H04W 4/023; H04W 4/04

(57) ABSTRACT

The position of a mobile device in a wireless network is refined by obtaining statistical samples of particles representing an initial estimated position of the device, obtaining one or more parameters of received signals from a set of one or more access points in the network, locking the set of one or more access points without using one or more additional access points to estimate the position, resampling the particles to obtain a second estimation of the position after locking the first set of one or more access points, and obtaining a refined estimated position based on a comparison of the first and second estimations of the position.

### FIELD OF DISCLOSURE

Various embodiments described herein relate to positioning in a wireless network, and more particularly, to positioning in a local wireless network.

### BACKGROUND

Local wireless networks, such as Wi-Fi networks, have been implemented for indoor and outdoor positioning. For example, a pedestrian equipped with a Wi-Fi enabled mobile device may be able to obtain an estimated position, also called a Wi-Fi fix, by communicating with one or more Wi-Fi access points.

In the absence of dedicated motion detectors, for example, inertial sensors, a typical Wi-Fi based pedestrian positioning system may not be able to obtain direct observation of pedestrian motion, and instead may rely on a predictive motion model for estimating the position of the pedestrian user. For example, a typical Wi-Fi based pedestrian positioning system may be implemented with a conventional predictive algorithm, which computes a predicted or estimated position of a pedestrian user at a future instant of time based on the time elapsed and a default motion model. As a consequence, when the pedestrian user is stationary, the estimated position of the user may continue to move, thereby resulting in large errors as the time elapses.

Moreover, even when the pedestrian user is stationary, the estimated position or Wi-Fi “fix” may often fluctuate in a typical Wi-Fi based pedestrian positioning system. In a given location, the Wi-Fi enabled mobile device may be within range of communications with multiple access points in a Wi-Fi network, for example. The Wi-Fi enabled mobile device may maintain a list of access points at a given time, and updates the list of access points after one or more existing access points drop out of range and one or more new access points come within range of the mobile device. Alternatively, the list of access points for the Wi-Fi enabled mobile device may be maintained by one or more access points within the Wi-Fi network, or by one or more positioning servers, or elsewhere within the Wi-Fi network infrastructure.

The list of access points for the Wi-Fi enabled mobile device is typically updated by passive or active scanning of Wi-Fi signals, for example, to determine which existing access point(s) currently on the list are out of range and which new access point(s) not currently on the list are within range and thus should be added to the list. Even when the mobile device is completely stationary, however, the list of access points may be unexpectedly updated or changed automatically by the mobile device because not all the access points within range of communications with the mobile device are “heard” by the mobile device in all iterations of passive or active scanning. Due to such unexpected changes in the list of access points even when the mobile device is stationary, the estimated position of the mobile device may sometimes fluctuate wildly, thereby failing to provide a Wi-Fi position “fix” to the pedestrian user.

### SUMMARY

Exemplary embodiments are directed to apparatus and method for refining an estimated position of a mobile device carried by, for example, a pedestrian or a vehicle, in communication with a wireless network, for example, a local wireless positioning network such as a Wi-Fi network, in an indoor or outdoor environment.

In an embodiment, a method of refining a position obtained from one or more access points in a wireless network is provided, the method comprising: obtaining statistical samples of particles representing the position based on a first estimation of the position; obtaining one or more parameters of received signals from a first set of one or more access points in the wireless network; locking said first set of one or more access points for position estimation based on said one or more parameters of the received signals from said first set of one or more access points; resampling the particles representing the position to obtain a second estimation of the position after locking said first set of one or more access points; and obtaining a refined estimated position based on a comparison of the first estimation and the second estimation of the position.

In another embodiment, an apparatus configured to perform operations to refine a position obtained from one or more access points in a wireless network is provided, the apparatus comprising: a memory; and a processor for executing a set of instructions stored in the memory, the set of instructions comprising instructions to: obtain statistical samples of particles representing the position based on a first estimation of the position; obtain one or more parameters of received signals from a first set of one or more access points in the wireless network; lock said first set of one or more access points for position estimation based on said one or more parameters of the received signals from said first set of one or more access points; resample the particles representing the position to obtain a second estimation of the position after locking said first set of one or more access points; and obtain a refined estimated position based on a comparison of the first estimation and the second estimation of the position.

In another embodiment, a non-transitory machine-readable storage medium encoded with instructions executable to refine a position obtained from one or more access points in a wireless network is provided, the instructions comprising: obtaining statistical samples of particles representing the position based on a first estimation of the position; obtaining one or more parameters of received signals from a first set of one or more access points in the wireless network; locking said first set of one or more access points for position estimation based on said one or more parameters of the received signals from said first set of one or more access points; resampling the particles representing the position to obtain a second estimation of the position after locking said first set of one or more access points; and obtaining a refined estimated position based on a comparison of the first estimation and the second estimation of the position.

### BRIEF DESCRIPTION OF THE DRAWINGS

The accompanying drawings are presented to aid in the description of embodiments and are provided solely for illustration of the embodiments and not limitations thereof.

FIG. 1 is a schematic diagram illustrating an embodiment of a position locating environment for a pedestrian carrying a mobile device utilizing a wireless network.

FIG. 2 is a flowchart illustrating an embodiment of a method of refining an estimated position obtained from one or more access points in a wireless network.

FIG. 3A is a diagram illustrating an example of a cluster of particles representing statistical samples of the estimated position of a stationary pedestrian carrying a mobile device in communication with a local wireless network before the position of the pedestrian is refined.

FIG. 3B is a diagram illustrating an example of a more concentrated cluster of particles representing statistical samples of the estimated position of the stationary pedestrian of FIG. 3A after a number of iterations of refinement.

FIG. 4 is a diagram illustrating an embodiment of an apparatus configured to refine an estimated position obtained from one or more access points in a wireless network.

### DETAILED DESCRIPTION

In an embodiment, the position of a mobile device in a wireless network is refined by obtaining statistical samples of particles representing an initial estimated position of the device, obtaining one or more parameters of received signals from a set of one or more access points in the network, locking the set of one or more access points without using one or more additional access points to estimate the position, resampling the particles to obtain a second estimation of the position after locking the first set of one or more access points, and obtaining a refined estimated position based on a comparison of the first and second estimations of the position.

In an embodiment, the position of the mobile device is further refined by resampling the particles representing the position based on one or more parameters of the received signals to obtain at least one additional estimation of the position after locking said first set of one or more access points, and obtaining a refined estimated position based on a comparison of the first estimation, the second estimation, and said at least one additional estimation of the position. In an embodiment, the wireless network comprises a Wi-Fi network. In an embodiment, one or more parameters of the received signals comprise a received signal strength parameter. In a further embodiment, the received signal strength parameter comprises a received signal strength indicator (RSSI).

The following description and related drawings are directed to specific embodiments. Alternate embodiments may be devised without departing from the scope of the claims. Additionally, well known elements will not be described in detail or will be omitted so as not to obscure the relevant details.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of the embodiments. As used herein, the singular forms “a,” “an,” and “the,” are intended to include the plural forms as well, unless the context clearly indicates otherwise. It will be further understood that the terms “comprises,” “comprising,” “includes,” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise.

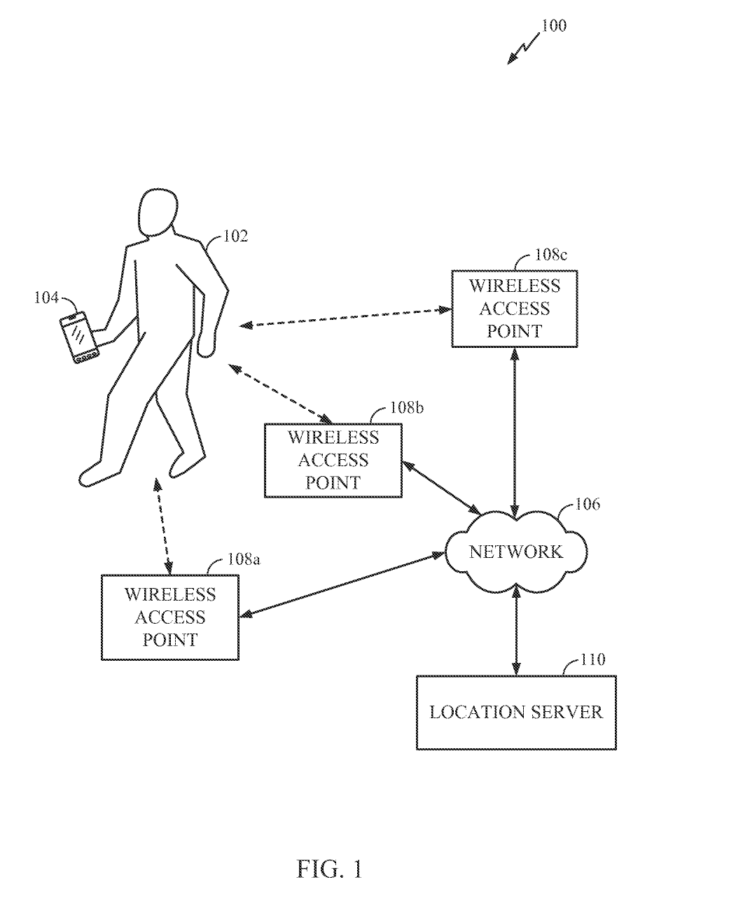

FIG. 1 is a schematic diagram illustrating a position locating environment 100, which may be an indoor or outdoor environment. A pedestrian 102 carrying a mobile device 104, such as a wireless telephone or tablet, for example, may be moving or stationary within the position locating environment 100. A wireless network 106, such as a local wireless network, is provided to assist in the positioning of the pedestrian 102. In an embodiment, the wireless network 106 comprises a Wi-Fi network compliant with one or more sets of specifications of the IEEE 802.11 standards, for example, although in alternative embodiments, other types of wireless networks such as Bluetooth® or ultra-wideband (UWB) networks may also be implemented for positioning.

In an embodiment, the wireless network 106 is equipped with a plurality of wireless access points 108a, 108b and 108c at various locations within the position locating environment 100 to assist in the positioning of the pedestrian 102. In an embodiment, each of the wireless access points 108a, 108b and 108c may comprise a Wi-Fi access point, a Wi-Fi hot spot or a Wi-Fi handheld device, for example. In alternative embodiments in which the wireless network comprises a Bluetooth® or UWB network, for example, the wireless access points 108a, 108b and 108c may each comprise a Bluetooth access point or a UWB access point, respectively. In an embodiment, the wireless network 106 may be connected to a location server 110 to assist in the positioning of the pedestrian 102. Although FIG. 1 illustrates a pedestrian 102 carrying a mobile device 104, the mobile device 104 may also be implemented in any means of transportation, for example, in a wheelchair, a bicycle, a Segway® personal transporter, a scooter, a motorcycle, or any type of motorized or non-motorized vehicle.

In the absence of inertial sensors, a typical positioning system such as one that relies on a local wireless network 106, for example, a Wi-Fi network, does not have a direct observation of the motion of the pedestrian 102. In the absence of direct observation of the pedestrian's motion, a default motion model may be used to predict the movement of the pedestrian 102. One example of such a default motion model is called a particle filter to model the movement of objects in two or three dimensions. In a typical particle filter model, a “particle,” which represents a statistical sample of a position of the pedestrian at a given time, may transition from an initial position to a subsequent position over a period of time in any one of an infinite number of directions from the initial position. Possible transitions to particular subsequent positions may be modeled according to a probabilistic model conditioned on the initial position. For example, the likelihood that a particle may have a particular subsequent location, velocity and heading may be conditioned on an initial location, velocity and heading for that particular particle.

In an embodiment, the particle filter may be implemented as a software program in the mobile device 104 carried by the pedestrian 102. Alternatively, the particle filter may be implemented as a software program in the wireless network 106, in the location server 110, or in one or more of the wireless access points 108a, 108b and 108c. If the particle filter is implemented outside of the mobile device 104 carried by the pedestrian 102, the estimated locations, velocities or headings resulting from particle filtering may be transmitted from one or more of the wireless access points 108a, 108b and 108c to the mobile device 104, for example.

In an embodiment, the mobile device 104 carried by the pedestrian 102 for position location maintains a dynamic list of access points which may be automatically updated when the pedestrian is moving, that is, when one or more of the existing access points on the list drop out of range of communications with the mobile device 104 and are thus deleted from the list, while one or more new access points come within the range of communications with the mobile device 104 and are thus added to the list. Alternatively, the list of access points for the mobile device 104 may be maintained elsewhere in the wireless network 106, for example, by one or more of the wireless access points 108a, 108b and 108c, or by the location server 110. As discussed above, even when the pedestrian 102 carrying the mobile device 104 for position location is stationary, the list of access points for the mobile device 104 in a conventional position locating scheme may be automatically updated or changed due to imperfect detection of access points within range of communications with the mobile device 104 by using conventional passive or active scanning techniques. In an embodiment, method and apparatus are provided to refine the estimated position of the mobile device 104 to obtain a stabilized position fix by locking down the list of access points for the mobile device 104, that is, without adding any other access points to the list for a period of time.

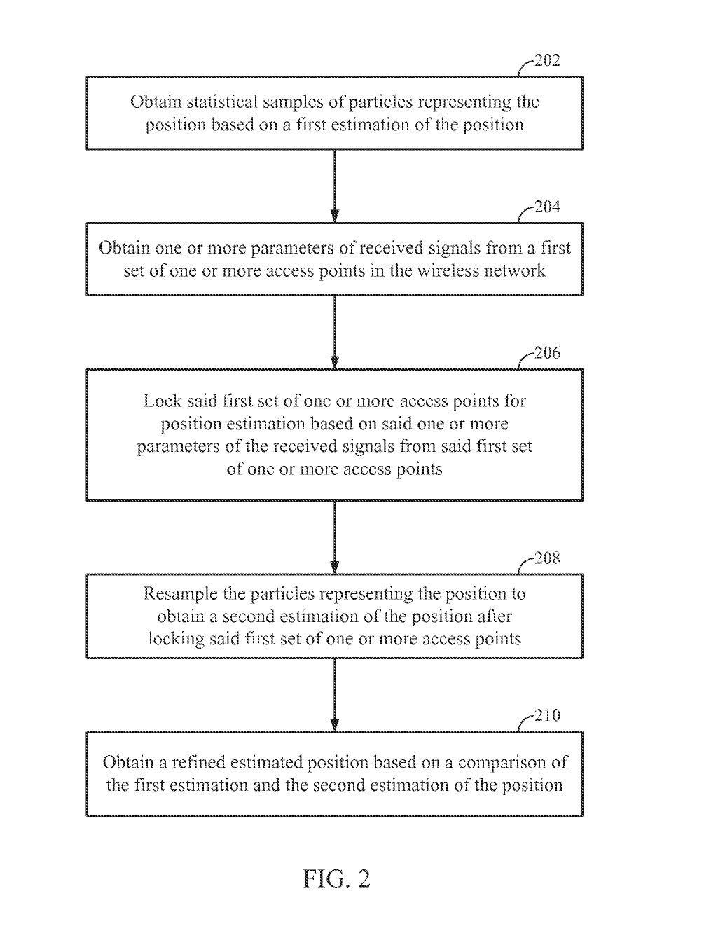

FIG. 2 is a flowchart illustrating an embodiment of a method of refining an estimated position obtained from one or more access points in a wireless network. In an embodiment, while the pedestrian 102 is stationary, statistical samples of particles representing the position of the mobile device 104, that is, the position of the pedestrian 102, are obtained based on a first estimation of the position, as shown in block 202. In an embodiment, statistical samples representing the position of the mobile device 104 may be obtained by running a particle filter in a normal mode. While the pedestrian 102 is stationary, the mobile device 104 maintains a list of access points, for example, access points 108a, 108b and 108c as shown in FIG. 1, which are within range of communications with the mobile device 104 and are capable of assisting in estimating the position of the mobile device 104.

Referring to FIG. 2, one or more parameters of received signals from a first set of one or more access points in the wireless network are obtained as shown in block 204, in order to lock down the first set of one or more access points already on the list for the mobile device 104. In an embodiment, one or more parameters of received signals from the first set of one or more access points may include a received signal strength parameter, for example. In an embodiment in which the wireless network 106 for position location comprises a Wi-Fi network, for example, the received signal strength parameter may include a received signal strength indicator (RSSI). In a further embodiment, one or more parameters of received signals from the first set of one or more access points may also include a round trip time (RTT), which is a parameter for indicating the round-trip time of signal travel from the mobile device 104 to an access point and back. In an alternate embodiment, only the RSSI is used as a parameter for locking down the first set of one or more access points for refining the estimated position of the mobile device 104 while the pedestrian 102 is stationary, without also using the RTT as an additional parameter. In yet another embodiment, only the RSSI is used as a parameter for locking down the first set of one or more access points for refining the estimated position while receiver gain learning is disabled.

After one or parameters of received signals from the first set of one or more access points in the wireless network are obtained as shown in block 202, the first set of one or more access points are locked down for position estimation based on said one or more parameters of the received signals from the first set of one or more access points, without using one or more additional access points to estimate the position of the mobile device 104, as shown in block 206 in FIG. 2. In an embodiment, a list of access points which has been maintained for the mobile device 104 for position location is locked down while the pedestrian 102 is stationary. In other words, the list of access points remains the same without adding new access points to the list or deleting existing access points from the list in a lock-down mode, even if the mobile device 104 has detected one or more new access points by passive or active scanning.

After the first set of one or more access points are locked down, particles representing the position of the pedestrian 102 are resampled, by a particle filter, for example, to obtain a second estimation of the position of the pedestrian 102, as shown in block 208 in FIG. 2. Because resampling of the particles as shown in block 208 is performed while the list of access points maintained for the mobile device 104 is in a lock-down mode, even if a new access point is detected by the mobile device 104, for example, by automatic passive or active scanning, the new access point is not added to the list and therefore not used in the resampling of the particles for refining the estimated position of the stationary pedestrian. The second estimation of the position of the pedestrian 102 obtained by resampling of particles as shown in block 208 may differ from the first estimation of the position of the pedestrian 102 obtained by the initial sampling of particles as shown in block 202. In an embodiment, the second estimation is compared to the first estimation to obtain a refined estimated position of the pedestrian 102 as shown in block 210. In a further embodiment, the step of resampling the particles as shown in block 208 and the step of obtaining a refined estimated position as shown in block 210 are repeated in one or more additional iterations to obtain a further refined estimated position of the pedestrian 102 while the pedestrian is stationary.

In an embodiment in which the wireless network 106 comprises a Wi-Fi network, the first estimation of the position of the pedestrian 102 may be obtained by running a particle filter in a normal mode by using both RSSI and RTT parameters, for example, while second and further refined subsequent estimations of the position of the pedestrian 102 are obtained by running the particle filter using only the RSSI parameters while the list of access points is maintained in a lock-down mode. In an embodiment, the particle filter for refining the estimated position while the pedestrian is stationary may be used for stabilizing the Wi-Fi position fix of the pedestrian. In a further embodiment, the particle filter for stabilizing the Wi-Fi position fix may be used as a motion detector. For example, if the pedestrian moves after a period of time of being stationary, for example, after multiple iterations of particle resampling have been run while the list of access points is in a lock-down mode, the particles may start to disperse along the direction of the movement of the pedestrian, thereby indicating that the pedestrian has begun moving.

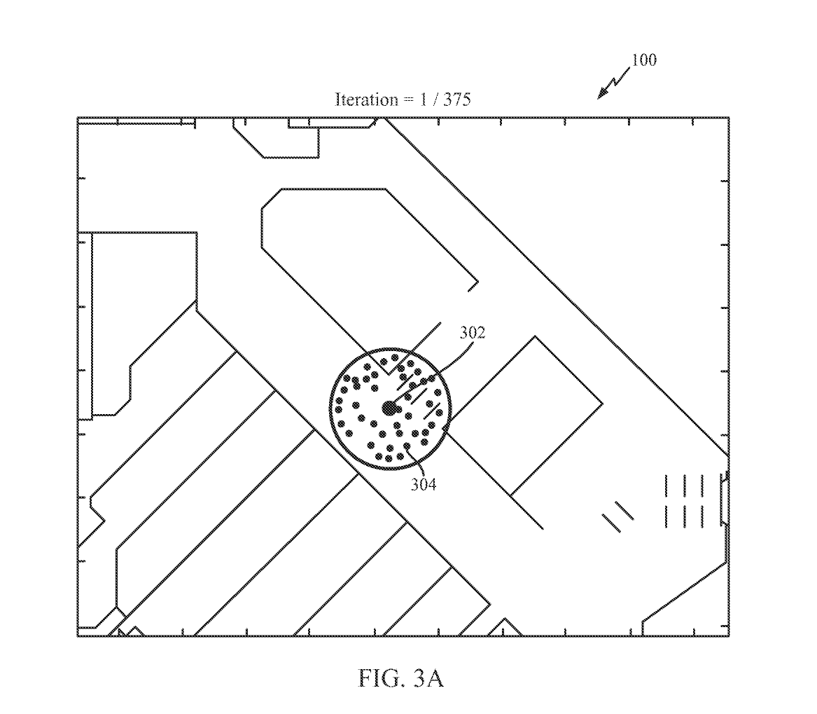

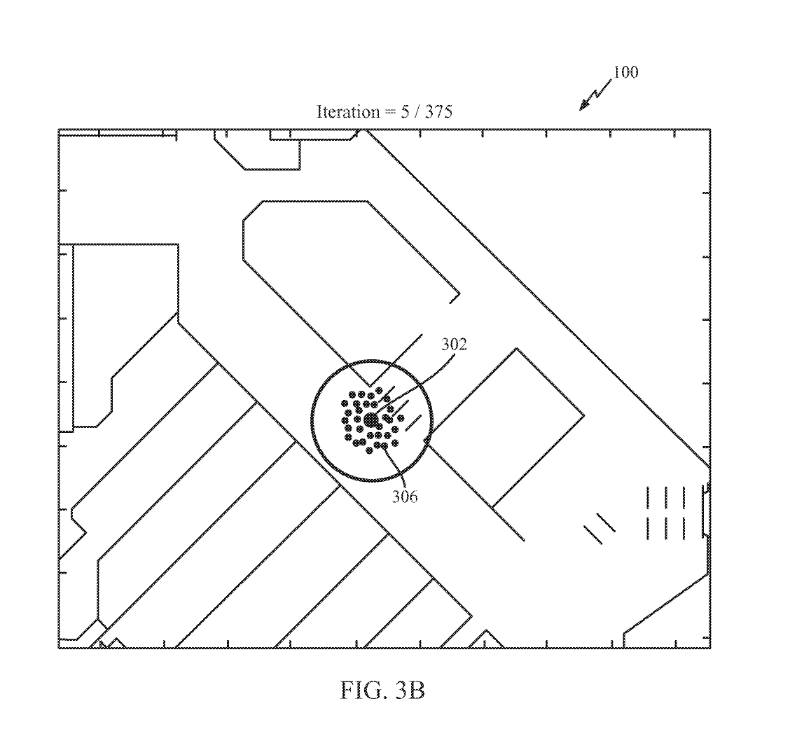

FIG. 3A is a diagram illustrating an example of a wide cluster of particles representing statistical samples of an initial estimated position of a stationary pedestrian carrying a mobile device in communication with a local wireless network before the position of the pedestrian is refined according to an embodiment. In FIG. 3A, the true position of the stationary pedestrian is indicated by a dot 302. The position locating environment 100 as illustrated in FIG. 3A may be an outdoor or indoor environment, for example, in a shopping mall. The particles representing statistical samples of the initial estimated position of the pedestrian are indicated by a plurality of dots in a cluster 304 spread out about the true position of the pedestrian as indicated by the dot 302. In an embodiment, the particles representing statistical samples of the initial estimated position are obtained by a particle filter running in a normal mode before the list of access points maintained for the mobile device is locked down. In a further embodiment, the particles representing statistical samples of the initial estimated position before the list of access points is frozen in a lock-down mode are obtained by running a particle filter using both RSSI and RTT parameters.

FIG. 3B is a diagram illustrating an example of a more concentrated cluster 306 of particles representing statistical samples of the estimated position of the stationary pedestrian of FIG. 3A after as few as five iterations of refinement according to an embodiment. As shown in FIG. 3B, many of the particles in the cluster 306 are generally closer to the true position of the pedestrian as indicated by the dot 302 than the particles in the initial cluster 304 in FIG. 3A. Further iterations of the resampling step as shown in block 208 and the position refining step in block 210 of FIG. 2 are expected to produce progressively smaller clusters of particles closer to the true position of the pedestrian as indicated by the dot 302 as shown in FIG. 3B.

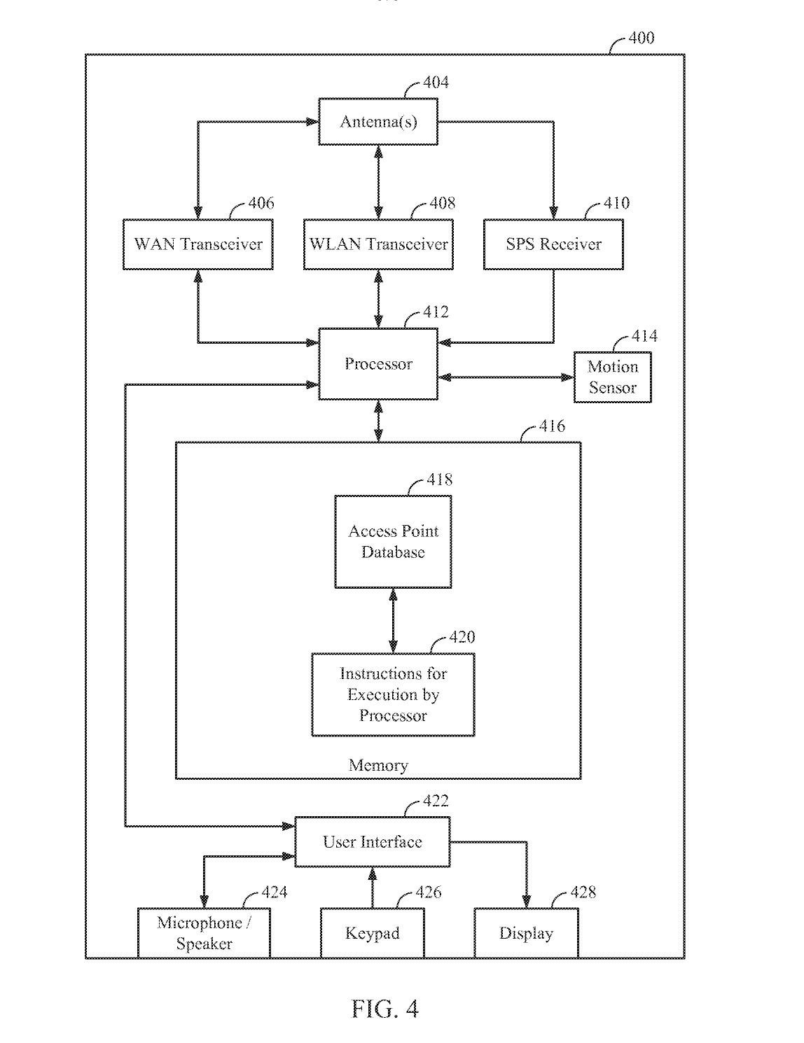

FIG. 4 is a block diagram illustrating an embodiment of an apparatus 400 configured to perform operations to refine an estimated position of the apparatus. The apparatus 400 as shown in FIG. 4 may be a mobile device, a handheld computer, or any type of positioning device capable of being carried by a pedestrian, for example. In the embodiment shown in FIG. 4, the apparatus 400 comprises one or more antennas 404, a wide area network (WAN) transceiver 406, a wireless local area network (WLAN) transceiver 408, and a satellite positioning system (SPS) receiver 410. In an alternate embodiment, the apparatus 400 may include a WLAN transceiver 408, such as a Wi-Fi transceiver, without an SPS receiver for satellite-based positioning, for example. In the embodiment shown in FIG. 4, a processor 412 is connected to the WAN transceiver 406, the WLAN transceiver 408 and the SPS receiver 410. Furthermore, a motion sensor 414 and a memory 416 are connected to the processor 412.

In an embodiment, the memory 416 includes an access point database 418 for maintaining a list of access points, which is locked down during the sampling and resampling processes to refine the position of the apparatus 400 according to embodiments described above. Alternatively, the list of access points may be stored elsewhere in the network, for example, in the location server 110 or in one or more of the access points 108a, 108b and 108c as shown in FIG. 1, for example. Referring back to FIG. 4, the memory 416 also includes memory 420 for storing instructions to be executed by the processor 412 to perform the process steps described above to refine the position of the apparatus 400, including, for example, the process steps as illustrated in the flowchart of FIG. 2. Those of skill in the art will appreciate that, in an embodiment, the apparatus 400 may be an integral part of a mobile device such as the mobile device 104 carried by the pedestrian 102 in FIG. 1. Furthermore, the apparatus 400 may also include a user interface 422, which may include hardware and software for interfacing inputs or outputs of the processor 412 with the user through light, sound or tactile inputs or outputs, for example. In the embodiment shown in FIG. 4, the apparatus 400 includes a microphone/speaker 424, a keypad 426, and a display 428 connected to the user interface 422. Alternatively, the user's tactile input or output may be integrated with the display 428 by using a touch-screen display, for example.

Although the apparatus 400 in the embodiment described above may be a mobile device, a handheld computer, or another type of pedestrian-carried device, those skilled in the art will also appreciate that, in an alternate embodiment, the apparatus 400 may be implemented elsewhere, in a device or system away from the pedestrian 102. For example, the apparatus 400 may be implemented in a network, such as the wireless network 106, in a server such as the location server 110, or in one or more wireless access points such as the wireless access points 108a, 108b and 108c as shown in FIG. 1. If the apparatus 400 is implemented in a device or system away from the pedestrian 102, the refined estimated position of the pedestrian computed by the apparatus 400 may be transmitted remotely to the mobile device 104 carried by the pedestrian 102 through one or more of the wireless access points 108a, 108b and 108c, for example.

Those of skill in the art will appreciate that information and signals may be represented by using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

Furthermore, many embodiments are described in terms of sequences of actions to be performed by, for example, elements of a computing device. It will be recognized that various actions described herein can be performed by specific circuits, such as application specific integrated circuits (ASICs), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The methods, sequences or algorithms described in connection with the embodiments disclosed herein may be embodied directly in hardware, in a software module executed by a processor, or in a combination of the two. A software module may reside in RAM, flash memory, ROM, EPROM, EEPROM, registers, a hard disk, a removable disk, a CD-ROM, or any other form of storage medium known in the art. An exemplary storage medium is coupled to the processor such that the processor can read information from, and write information to, the storage medium. In an alternative, the storage medium may be integral to the processor.

Accordingly, an embodiment can include a computer or machine readable medium embodying a method of refining an estimated position by one or more access points 108a, 108b or 108c in a wireless network 106. Accordingly, the claims are not limited to illustrated examples and any means for performing the functionality described herein are included in various embodiments.

While the foregoing describes illustrative embodiments, it should be noted that various changes and modifications could be made herein without departing from the scope as defined by the appended claims. The functions, steps or actions in the method and apparatus claims in accordance with the embodiments described herein need not be performed in any particular order unless explicitly stated otherwise. Furthermore, although elements may be described or claimed in the singular, the plural is contemplated unless limitation to the singular is explicitly stated.

What is claimed is:

1. A method of refining a position of a device obtained from one or more access points in a wireless network, comprising:
obtaining statistical samples of particles representing the position based on a first estimation of the position;
obtaining one or more parameters of received signals from a first set of one or more access points in the wireless network;
locking said first set of one or more access points for position estimation based on said one or more parameters of the received signals from said first set of one or more access points;
resampling the particles representing the position to obtain a second estimation of the position after locking said first set of one or more access points; and
obtaining a refined estimated position based on a comparison of the first estimation and the second estimation of the position.

2. The method of claim 1, further comprising:
resampling the particles representing the position based on one or more parameters of the received signals to obtain at least one additional estimation of the position after locking said first set of one or more access points; and
obtaining a refined estimated position based on a comparison of the first estimation, the second estimation, and said at least one additional estimation of the position.

3. The method of claim 1, wherein said one or more parameters of the received signals comprise a received signal strength parameter.

4. The method of claim 3, wherein the received signal strength parameter comprises a received signal strength indicator (RSSI).

5. The method of claim 1, wherein said one or more parameters of the received signals further comprise a round trip time (RTT).

6. The method of claim 1, wherein the wireless network comprises a Wi-Fi network.

7. The method of claim 1, wherein said one or more access points comprise one or more Wi-Fi access points.

8. An apparatus configured to perform operations to refine a position obtained from one or more access points in a wireless network, the apparatus comprising:
a memory; and
a processor for executing a set of instructions stored in the memory, the set of instructions comprising instructions to:
obtain statistical samples of particles representing the position based on a first estimation of the position;
obtain one or more parameters of received signals from a first set of one or more access points in the wireless network;
lock said first set of one or more access points for position estimation based on said one or more parameters of the received signals from said first set of one or more access points;
resample the particles representing the position to obtain a second estimation of the position after locking said first set of one or more access points; and
obtain a refined estimated position based on a comparison of the first estimation and the second estimation of the position.

9. The apparatus of claim 8, wherein the set of instructions further comprise instructions to:
resample the particles representing the position based on one or more parameters of the received signals to obtain at least one additional estimation of the position after locking said first set of one or more access points; and
obtain a refined estimated position based on a comparison of the first estimation, the second estimation, and said at least one additional estimation of the position.

10. The apparatus of claim 8, wherein said one or more parameters of the received signals comprise a received signal strength parameter.

11. The apparatus of claim 10, wherein the received signal strength parameter comprises a received signal strength indicator (RSSI).

12. The apparatus of claim 8, wherein said one or more parameters of the received signals further comprise a round trip time (RTT).

13. The apparatus of claim 8, wherein the wireless network comprises a Wi-Fi network.

14. The apparatus of claim 8, wherein said one or more access points comprise one or more Wi-Fi access points.

15. A non-transitory machine-readable storage medium encoded with instructions executable to refine a position of a device by one or more access points in a wireless network, the instructions comprising:
obtaining statistical samples of particles representing the position based on a first estimation of the position;
obtaining one or more parameters of received signals from a first set of one or more access points in the wireless network;
locking said first set of one or more access points for position estimation based on said one or more parameters of the received signals from said first set of one or more access points;
resampling the particles representing the position to obtain a second estimation of the position after locking said first set of one or more access points; and
obtaining a refined estimated position based on a comparison of the first estimation and the second estimation of the position.

16. The non-transitory machine-readable storage medium of claim 15, wherein the instructions further comprise:
resampling the particles representing the position based on one or more parameters of the received signals to obtain at least one additional estimation of the position after locking said first set of one or more access points; and
obtaining a refined estimated position based on a comparison of the first estimation, the second estimation, and said at least one additional estimation of the position.

17. The non-transitory machine-readable storage medium of claim 15, wherein said one or more parameters of the received signals comprise a received signal strength parameter.

18. The non-transitory machine-readable storage medium of claim 17, wherein the received signal strength parameter comprises a received signal strength indicator (RSSI).

19. The non-transitory machine-readable storage medium of claim 15, wherein said one or more parameters of the received signals further comprise a round trip time (RTT).

20. The non-transitory machine-readable storage medium of claim 15, wherein the wireless network comprises a Wi-Fi network.
